(19) United States
(12) Patent Application Publication
(10) Pub. No.: US 2006/0042503 A1
(43) Pub. Date: Mar. 2, 2006

(54) Composition of anti-rust product used in non-plating mould

(76) Inventors: Hee-Dae Park, Busan (KR); Metha Yagnick, Rahway, NJ (US)

Correspondence Address: ST. ONGE STEWARD JOHNSTON & REENS, LLC, 986 BEDFORD STREET, STAMFORD, CT, 06905-5619, US

(21) Appl. No.: 10/930,348

(22) Filed: Aug. 31, 2004

(51) Int. Cl. C04B 9/02

(52) U.S. Cl. 106/14.05

(57) ABSTRACT

Disclosed is a composition of an anti-rust agent used in a non-plating mold on which a noxious substance such as chrome or Teflon is not coated. The composition consists a hydrophobic nonionic surfactant and glycol.

### FIELD OF THE INVENTION

The present invention relates to a composition of an anti-rust agent or product, and more particularly, to a composition of an anti-rust agent used in a non-plating mould/mold on which a noxious substance such as chrome or Teflon is not coated.

### BACKGROUND OF THE RELATED ART

Generally, corrosion of a mold is resulted from that the surface of metal reacts to substances such as water, air (in particular, oxygen), chloride ion, or the like and is transformed into oxides (Fe₂O₃, FeO, Fe₃O₄ or the like) or hydroxide. For a steel mold, a surface of the mold has an affinity for oxygen. When the steel is exposed for a long period under the air, the surface of the steel is easily oxidized to form a corrosive layer. As such, the surface of the steel mold becomes rough, which is a primary factor of obstructing release of a rubber. Consequently, the corrosion of the mold is of interest.

In particular, such a problem is frequently presented in a non-plating mold for manufacturing an outsole of shoes, as shown in FIGS. 1 and 2. The reason is because the mold is made of a material such as carbon steel, not alloy steel. The carbon steel should be undergone with an anti-rust treatment.

### SUMMARY OF THE INVENTION

Accordingly, the present invention is directed to a composition of an anti-rust agent that substantially obviates one or more problems due to limitations and disadvantages of the related art.

An object of the present invention is to provide a composition of an anti-rust agent used in a non-plating mold on which a noxious substance such as chrome or Teflon is not coated.

Another object of the present invention is to provide a composition of an anti-rust agent capable of preventing a surface of a mold to produce a sole of shoes from being corroded.

To achieve the object and other advantages, according to one aspect of the present invention, there is provided a composition of an anti-rust agent for use in a non-plating mold, the composition consisting of a hydrophobic nonionic surfactant and glycol. Additives, such as blend of fluoro-polymeric resin and acrylate copolymer, aliphatic or cyclic solvent, FEP(120J), non-ionic organic surfactant, MEG, IPA or the like, are added into the anti-dust agent. It can select some of the above components, depending upon the kind of the mold (for example, steel mold or aluminum mold).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view depicting a surface state of a conventional non-plating mold;

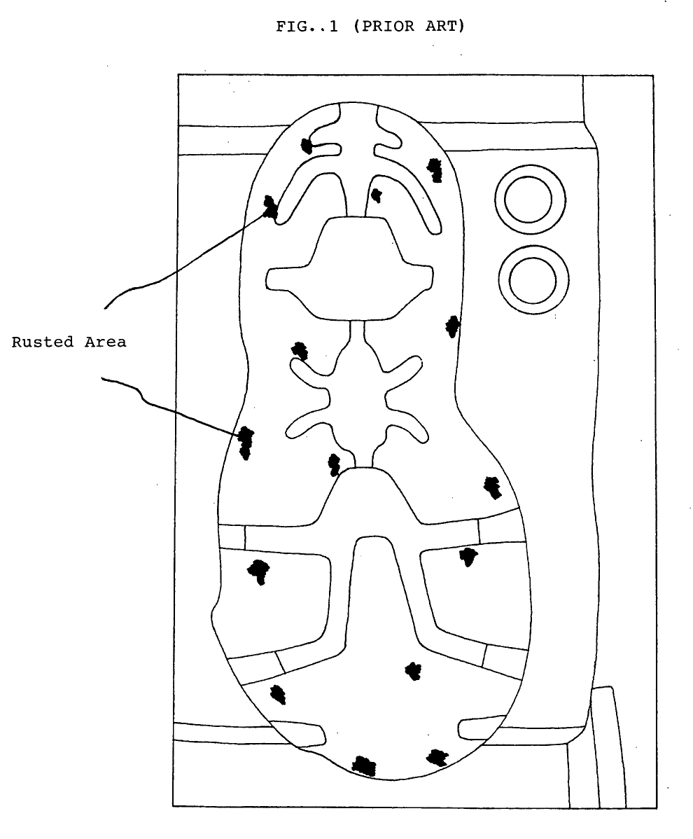

FIG. 2 is an enlarged view depicting the state where a surface of the mold in FIG. 1 rusts;

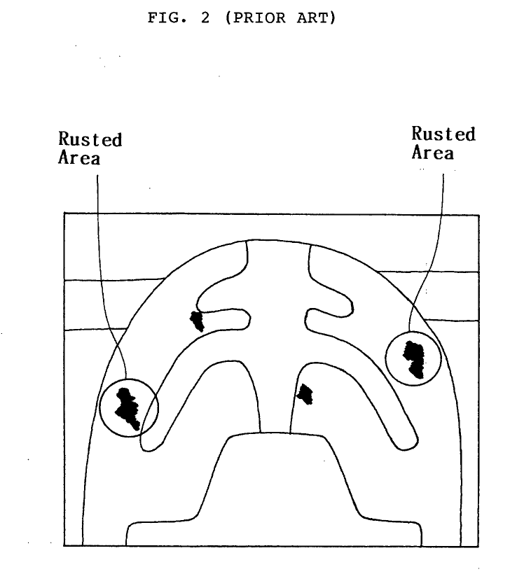

FIG. 3 is a view depicting a surface state of a non-plating mold coated with an anti-rust agent according to a preferred embodiment of the present invention; and

FIG. 4 is an enlarged view depicting a state where a surface of the mold in FIG. 3 does not rust.

### DETAILED DESCRIPTION OF THE PREFERRED EMBODIMENTS

A preferred embodiment according to the present invention will now be explained with reference to the accompanying drawings. The below described embodiments of the present invention are intended to be illustrative only. Those skilled in the art may devise numerous alternative embodiments without departing from the scope of the following claims.

The present invention teaches a composition of an anti-rust agent capable of keeping a surface of a non-plating mold in a consistent state, without coating the surface with a noxious substance such as chrome or Teflon, which prevents an embossing phenomenon of the mold due to an acid and a corrosion phenomenon due to moisture.

Such an anti-rust agent may be applied to a mold for producing a sole of shoes to effectively achieve a good performance. In particular, the anti-rust agent of the present invention can be applied to the surface of the mold disclosed by Korean Patent Application No. 2004-0000 entitled “composition of master batch and outsole made from the same”, of which is invented by the inventor and is incorporated by reference therein. The anti-rust agent mainly consists of a hydrophobic nonionic surfactant and glycol. The anti-rust agent has an advantage of cleaning the surface of the mold.

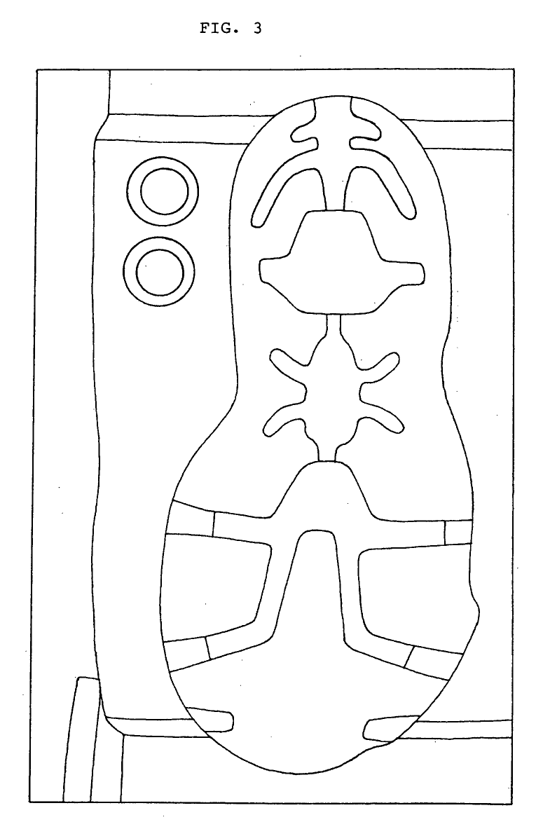

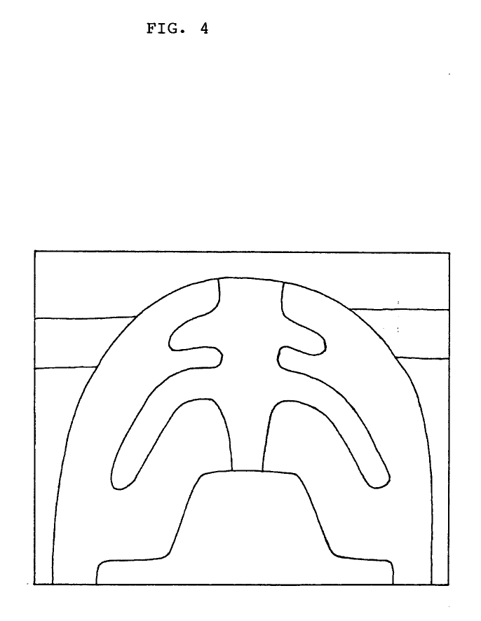

The anti-rust agent of the present invention is used for the mold, which is left during a long period. Specifically, when outsoles of shoes are produced by use of the mold immediately after the surface of the mold is treated with glass beads, the mold is treated through a sulfur master batch or a master batch of titanium dioxide, which is disclosed in the above patent application. In the case of leaving the mold during a long period, the surface of the mold is applied with the anti-rust agent of the present invention, so that the mold does not rust to always keep the surface in the clean state, as shown in FIGS. 3 and 4.

Prior to application of the anti-rust agent of the present invention, the surface of the mold is treated by a general blasting machine with glass beads (#80, 150 to 220 μm, 2.5 g/cc) to eliminate impurities from the surface of the mold and to provide a constant roughness, the detailed description of which is as followings.

The mold for manufacturing the outsole mainly consists of Fe, but other metallic components are contained in the mold. Since the surface is a crystal structure of a given air permeability, the surface should be undergone through the blasting process to minimize the crystal structure and make it consistently. To this end, according to the present invention, the blasting process is repeatedly carried out in a perpendicular direction to the surface of the mold to be rotated by 90 degrees. A size of the glass bead is #80, and the blasting process is performed under pressure of about 5 bars. Broken glass beads are collected or replaced. If the blasting process is performed under lower pressure or using small size of glass beads, a reflective surface is formed on the mold. Therefore, the blasting is maintained under the pressure of 5 to 6 bars.

Preferred embodiments of the present invention will now be described in detail, but the present invention is not restricted thereto.

### Embodiment 1

An anti-dust agent (Moldface F7A; brand name) was produced by mixing a blend of fluoro-polymeric resin and acrylate copolymer of 5 to 6 wt. %, and aliphatic or cyclic solvent of 94 to 95 wt. %.

### Embodiment 2

An anti-dust agent (Moldface P5; brand name) was produced by polyether emulsion.

### Embodiment 3

An anti-dust agent (Moldface IM8) was produced by mixing propylene glycol monomethyl ether 46 to 47 wt. %, isopropyl alcohol of 46 to 67 wt. %, and FEP(120J) which consists of tetrafluoroethylene hexafluoropropylene copolymer of 53 to 56 wt. %, octyl phenoxypolyethoxyethanol of 0 to 3.3 wt. %, nonyl phenoxypolyethoxyethanol of 0 to 3.3 wt. %, water of 40 to 45 wt. %, fluoro-ester of up to 0.5 wt. %, and surfactant of small quantities.

It would be apparent from some tests that Moldface F7A and Moldface P5 are more suitable for the steel mold, and Moldface IM8 is more suitable for the aluminum mold.

In addition, superior effects can be obtained by executing the blasting process on the surface of the mold by use of glass beads, prior to the application of the anti-rust agent of the present invention onto the outsole mold.

With the above description, the present invention can eliminate impurities from the surface of the mold and keep a roughness of the surface in consistent by use of the glass beads.

In addition, since the anti-rust agent of the present invention is applied onto the mold, it is possible to keep the mold during a long period, with an anti-rust effect against the moisture being embodied and contamination of the mold being prevented.

The foregoing embodiments are merely exemplary and are not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. A composition of an anti-rust agent for use in a non-plating mold, the composition consisting of: a hydrophobic nonionic surfactant and glycol.

2. The composition as claimed in claim 1, wherein the composition consists of a blend of fluoro-polymeric resin and acrylate copolymer, and aliphatic or cyclic solvent.

3. The composition as claimed in claim 1, wherein the composition consists of non-ionic organic surfactant, propylene glycol monomethyl ether, and isopropyl alcohol.

4. The composition as claimed in claim 1, wherein the composition consists of a mixture of tetrafluoroethylene hexafluoropropylene copolymer, octyl phenoxypolyethoxyethanol, nonyl phenoxypolyethoxyethanol, water of 40 to 45 wt. %, fluoro-ester of up to 0.5 wt. %, and surfactant of small quantities; propylene glycol monomethyl ether; and isopropyl alcohol.

5. The composition as claimed in claim 1, wherein the mold is to manufacture an outsole of shoes.

6. The composition as claimed in claim 5, wherein prior to the anti-rust agent is applied to the mold, a blasting process with a glass bead is treated on a surface of the mold.

7. The composition as claimed in claim 6, wherein a size of the glass bead is in a range of 150 to 200 μm, and the blasting process is executed in a pressure of 5 to 6 bars.
